(19) United States
(12) Patent Application Publication
(10) Pub. No.: US 2025/0266016 A1
(43) Pub. Date: Aug. 21, 2025

(54) DISPLAY CONTROL SYSTEM AND DISPLAY CONTROL METHOD

(71) Applicant: Panasonic Automotive Systems Co., Ltd., Kanagawa (JP)

(72) Inventors: Chikara YOSHIDA, Kanagawa (JP); Seiichi NAKAGAWA, Kanagawa (JP); Takafumi NOGUCHI, Tokyo (JP); Atsushi NAGAMI, Kanagawa (JP)

(73) Assignee: Panasonic Automotive Systems Co., Ltd., Kanagawa (JP)

(21) Appl. No.: 19/056,292

(22) Filed: Feb. 18, 2025

(30) Foreign Application Priority Data
Feb. 20, 2024 (JP) 2024-023772

(51) Int. Cl. G09G 5/377; G09G 5/373

(52) U.S. Cl. CPC G09G 5/377; G09G 5/373; G09G 2340/0464; G09G 2380/10

(57) ABSTRACT

A GUIApp of an IVI processor generates data of a third GUI object including a first GUI object and a second GUI object in which a numerical value related to a display mode of the first GUI object is set as color information. A GUI framework of the IVI processor generates an image of the third GUI object based on the data of the third GUI object. A video compositor of a meter processor displays the first GUI object in a mode based on the color information of the second GUI object included in the image of the third GUI object.

### BACKGROUND

### 1. Field

The present disclosure relates to a data processing technology, and more particularly, to a display control system and a display control method.

### 2. Description of the Related Art

The patent document 1 below describes an image integration unit that combines images generated by a plurality of application units and outputs the composite image to a plurality of displays. The image integration unit includes a controller that controls which screen of an application unit is displayed on each display. Each application unit generates pieces of screen data of two or more display modes (such as a normal mode and a simple mode). The controller selectively combines the pieces of screen data according to characteristics of each display, and outputs a combination result to each display.
[patent document 1] WO 2014/118943 A

In the display control system described in the patent document 1, the application unit generates an image according to a layout designated by the image integration unit. There is a time lag between when the image integration unit designates layout information and when an image according to the layout information is generated, and the time lag depends on processing performance of the application unit. Therefore, the image integration unit cannot accurately determine whether the image acquired from the application unit has been created according to old layout information or new layout information. Therefore, in a case where the layout changes, it may be difficult to synchronize a timing at which the image is acquired from the application unit with a timing at which the layout changes, and expression such as animation may be limited.

### SUMMARY

One object of the present disclosure is to provide a technology for supporting accurate synchronization between an image and a layout.

In order to solve the above problem, a display control system according to one aspect of the present disclosure includes: a generator structured to generate data of a third GUI object including a first GUI object and a second GUI object in which a numerical value related to a display mode of the first GUI object is set as color information; a renderer structured to generate an image of the third GUI object based on the data of the third GUI object; and a display controller structured to display the first GUI object in a mode based on the color information of the second GUI object included in the image of the third GUI object.

Another aspect of the present disclosure is a display control method. The method is executed by a computer and includes: generating data of a third GUI object including a first GUI object and a second GUI object in which a numerical value related to a display mode of the first GUI object is set as color information; generating an image of the third GUI object based on the data of the third GUI object; and displaying the first GUI object in a mode based on the color information of the second GUI object included in the image of the third GUI object.

Note that arbitrary combinations of the above constituent elements and modifications of the expressions of the present disclosure in apparatuses, computer programs, recording media recording computer programs, and the like are also effective as aspects of the present disclosure.

### BRIEF DESCRIPTION OF THE DRAWINGS

FIG. 1 is a block diagram illustrating functional blocks of a display control system according to an embodiment;

FIG. 2 is a diagram illustrating an example of in-vehicle infotainment (IVI) display data;

FIG. 3 is a diagram illustrating an example of layout information;

FIG. 4 is a diagram for describing a problem of a related technology;

FIG. 5 is a flowchart illustrating an operation of an in-vehicle infotainment (IVI) device;

FIG. 6 is a diagram illustrating an example of layout-added IVI display data;

FIG. 7 is a diagram illustrating an example of a layout-added IVI image;

FIG. 8 is a diagram illustrating an example of layout information; and

FIG. 9 is a flowchart illustrating an operation of a meter device.

### DETAILED DESCRIPTION OF THE EMBODIMENTS

The invention will now be described by reference to the preferred embodiments. This does not intend to limit the scope of the present invention, but to exemplify the invention.

A subject of an apparatus or method in the present disclosure includes a computer. The computer executes a program, thereby implementing functions of the subject of the apparatus or method in the present disclosure. The computer includes a processor that operates according to the program as a main hardware configuration. A type of the processor is not limited as long as the processor can implement the functions by executing the program. The processor includes one or more electronic circuits including a semiconductor integrated circuit (IC) or a large scale integration (LSI). Although the electronic circuits are referred to as the IC or the LSI here, the terms vary depending on the degree of integration, and may be referred to as a system LSI, a very large scale integration (VLSI), or an ultra large scale integration (ULSI). A field programmable gate array (FPGA), which is programmed after manufacturing of the LSI, or a reconfigurable logic device capable of reconfiguring a bonding relationship inside the LSI or setting up a circuit section inside the LSI can also be used for the same purpose. The plurality of electronic circuits may be integrated on one chip or may be provided on a plurality of chips. The plurality of chips may be integrated into one apparatus or may be provided in a plurality of apparatuses. The program may be recorded in a non-transitory recording medium such as a computer-readable read only memory (ROM), an optical disk, or a hard disk drive, or may be recorded in a transitory storage medium such as a computer-readable random access memory (RAM). The program may be stored in advance in a recording medium, or may be supplied to a recording medium or a storage medium via a wide area communication network including the Internet or the like.

A display control system according to an embodiment is a system including two or more processors mounted on physically different units. The two or more processors include an in-vehicle infotainment (IVI) side processor and a meter side processor. The IVI side processor includes a general operating system (OS) for IVI and a graphical user interface (GUI) application that operates on the OS. The OS includes a GUI framework and a window system. The GUI application uses the GUI framework and the window system to generate an image to be displayed on an IVI display and an image (for example, an image indicating navigation information) to be displayed on a display of a meter. The latter image is transmitted to the meter side processor via the window system.

The image transmitted from the IVI side processor to the meter side processor includes a color information region (“IVI image” described below) in which color information of a GUI object is stored and a layout region (“layout image” described below) in which a numerical value related to a display mode (also referred to as display layout) of an image of the color information region is stored as color information. The meter side processor causes the display of the meter to display the image of the color information region in a mode based on the color information of the layout region. In the embodiment, the meter side processor displays a composite image obtained by combining the image of the color information region with a predetermined image generated in the meter in a composite mode based on the color information of the layout region. The “image” in the embodiment includes one or both of a video (moving image) and a still image.

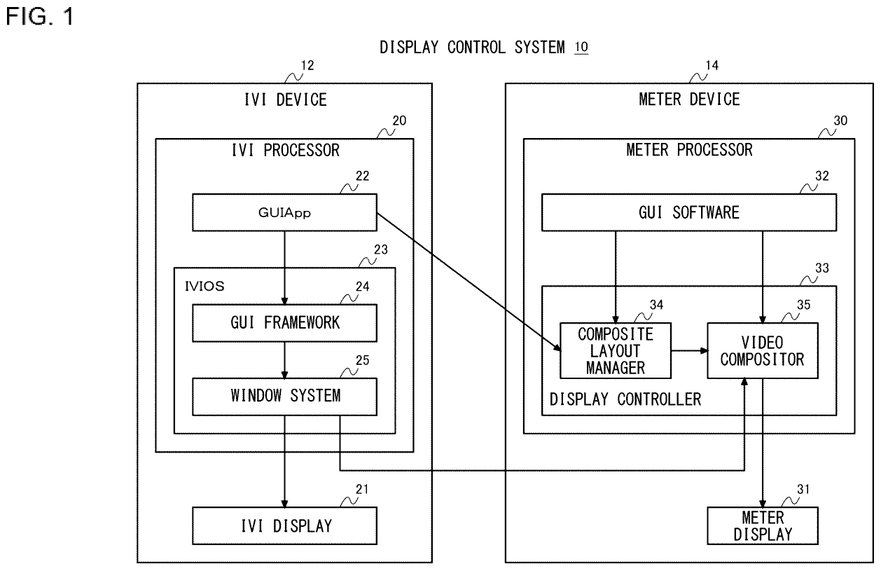

FIG. 1 is a block diagram illustrating functional blocks of a display control system 10 according to the embodiment. Each block illustrated in the block diagram according to the present disclosure can be implemented by an element such as a central processing unit (CPU) or a memory of a computer or a mechanical apparatus in terms of hardware, and is implemented by a computer program or the like in terms of software, but here, functional blocks implemented by a combination thereof are illustrated. It is understood by those skilled in the art that the functional blocks can be implemented in various forms by a combination of hardware and software.

The display control system 10 is a data processing system constructed in a vehicle. The display control system 10 includes an IVI device 12 and a meter device 14. The IVI device 12 is an in-vehicle information device that executes processing such as navigation, streaming of a moving image, and music reproduction. The meter device 14 is a device that executes processing related to display of the meter of the vehicle, such as a speedometer or an engine tachometer. The IVI device 12 and the meter device 14 have different safety requirements. That is, the meter device 14 is required to have higher safety than the IVI device 12. Safety refers to not only security but also robustness or accuracy of information.

The IVI device 12 and the meter device 14 transmit and receive a video signal by using a general-purpose video transmission interface such as a gigabit video interface (GVIF) (registered trademark), a high-definition multimedia interface (HDMI) (registered trademark), or a gigabit multimedia serial link (GMSL). The IVI device 12 and the meter device 14 transmit and receive a message (for example, layout information) by using a data transmission interface such as TCP/IP different from the video transmission interface.

The IVI device 12 includes an IVI processor 20 and an IVI display 21. The IVI processor 20 executes various types of data processing in the IVI device 12. The IVI processor 20 includes a CPU and a memory. The IVI processor 20 may be implemented as an electronic control unit (ECU) or a system on a chip (SoC). The IVI display 21 displays the IVI image output from the IVI processor 20. The IVI image may include, for example, a navigation image or a streamed video.

The IVI processor 20 includes a GUIApp 22 and an IVIOS 23. A function of each functional block in the IVI processor 20 may be implemented in a computer program. The IVI processor 20 may perform the function of each functional block by executing the computer program.

The IVIOS 23 is a general OS (in other words, system software) introduced into the IVI processor 20. The IVIOS 23 includes a GUI framework 24 and a window system 25. The GUIApp 22 is a GUI application that operates on the IVIOS 23 and generates an image related to IVI.

The meter device 14 includes a meter processor 30 and a meter display 31. The meter processor 30 executes various types of data processing in the meter device 14. The meter processor 30 includes a CPU and a memory. The meter processor 30 may be implemented as an ECU or an SoC. The meter display 31 displays images of various meters output from the meter processor 30.

The meter processor 30 includes a GUI software 32 and a display controller 33. A function of each functional block in the meter processor 30 may be implemented in a computer program. The meter processor 30 may perform the function of each functional block by executing the computer program.

The GUI software 32 generates the images of various meters. The images of the meters include, for example, an image of the speedometer and an image of the engine tachometer. The GUI software 32 may include a GUI application, a GUI framework, and a window system. The display controller 33 controls display contents of the meter display 31. The display controller 33 causes the meter display 31 to display a meter image output from the GUI software 32.

The display control system 10 according to the embodiment causes the meter display 31 to display a composite image obtained by combining a GUI image related to IVI and generated by the IVI processor 20 with the meter image generated by the meter processor 30. First, a configuration related to display of a composite image according to a related art will be described.

The GUIApp 22 of the IVI processor 20 as a generator generates data of a first GUI object including information regarding IVI (hereinafter, also referred to as “IVI display data”). The IVI display data is data of the GUI object using a GUI component prepared in advance. In the embodiment, the GUI component prepared in advance is a GUI component defined in hypertext markup language (HTML). The IVI display data according to the embodiment is data using one or more GUI components (for example, a container and a button) selected by a developer (a screen designer or the like) from among a plurality of GUI components defined by HTML. The IVI display data may be an HTML document. The GUIApp 22 outputs the IVI display data to the GUI framework 24.

The GUI framework 24 of the IVI processor 20 as a renderer generates data of the GUI image related to IVI (hereinafter, also referred to as “IVI image”) based on the IVI display data. The GUI framework 24 includes, for example, an HTML rendering engine. The IVI image is an image to be combined with the meter image, and includes the GUI object indicating the information regarding IVI. Data of the IVI image includes a pixel value of the GUI object.

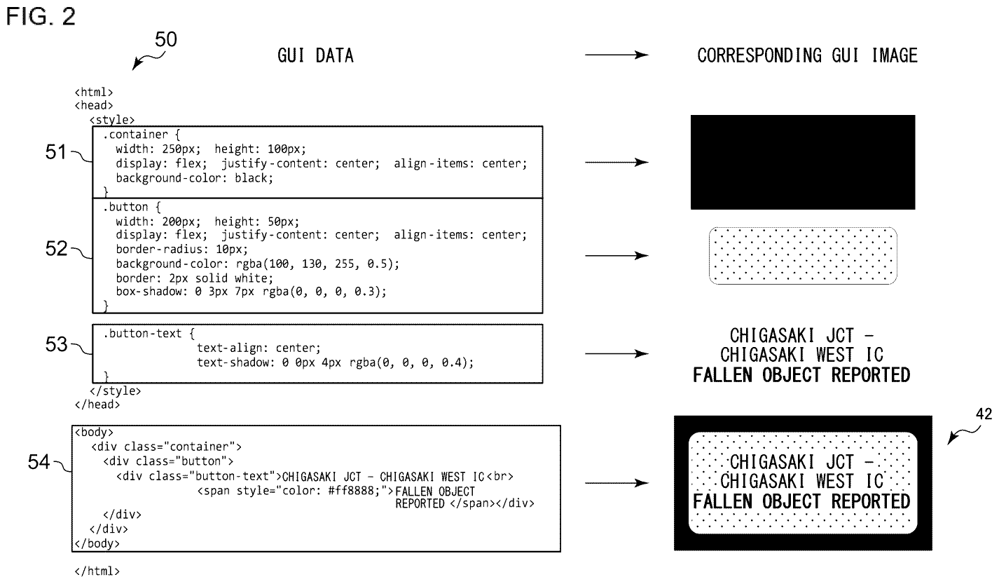

FIG. 2 illustrates an example of the IVI display data. IVI display data 50 includes container style data 51, button style data 52, text style data 53, and content data 54. The container style data 51 is data that defines a style of a container object. The button style data 52 is data that defines a style of a button object. The text style data 53 is data that defines a style of text. The content data 54 is data that designates a content to be displayed on a screen (that is, an IVI image 42).

Returning to FIG. 1, the window system 25 of the IVI processor 20 includes a frame buffer that temporarily stores image data. The GUI framework 24 stores the generated data of the IVI image in the frame buffer. The window system 25 transmits the data of the IVI image stored in the frame buffer to the meter device 14 via the video transmission interface.

In addition, the GUIApp 22 of the IVI processor 20 further generates the layout information that designates a display mode of the IVI image on the meter display 31. The GUIApp 22 transmits the layout information to the meter device 14 via the data transmission interface different from the video transmission interface.

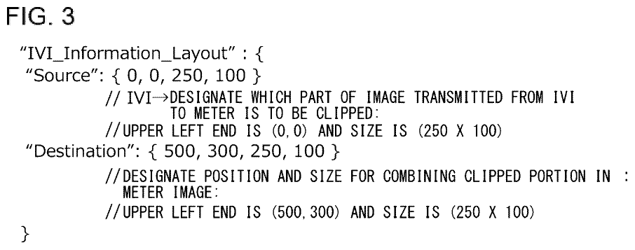

FIG. 3 illustrates an example of the layout information. The layout information includes a source attribute and a destination attribute. The source attribute is information that designates a position of a clipping region. For example, the source attribute includes a horizontal coordinate and a vertical coordinate of an upper left end of the IVI image in the image data input from the IVI device 12 to the meter device 14, and a size (a horizontal width and a vertical width) of the IVI image. The destination attribute is information that designates a position to be combined. For example, the destination attribute includes a horizontal coordinate and a vertical coordinate of an upper left end of a region to be combined with the IVI image in the meter image, and a size (a horizontal width and a vertical width) of the region to be combined.

The GUI software 32 of the meter device 14 generates images of various meters. The GUI software 32 further generates layout information that defines a display mode of the meter image. The display controller 33 of the meter device 14 includes a composite layout manager 34 and a video compositor 35. The GUI software 32 outputs data of the meter image to the video compositor 35 and outputs the layout information to the composite layout manager 34.

The composite layout manager 34 acquires the layout information of the IVI image transmitted from the IVI processor 20 via the data transmission interface. In addition, the composite layout manager 34 acquires the layout information of the meter image output from the GUI software 32. The composite layout manager 34 inputs the layout information of the IVI image and the layout information of the meter image to the video compositor 35.

The video compositor 35 receives the IVI image (for example, the IVI image 42) transmitted from the IVI processor 20 via the video transmission interface, and generates data of a composite image in which the received IVI image is superimposed on the meter image output from the GUI software 32. The video compositor 35 combines the IVI image with a region of the meter image designated according to the destination attribute of the layout information of the IVI image input from the composite layout manager 34. The video compositor 35 may generate the composite image by using a known alpha blend. The video compositor 35 outputs data of the composite image to the meter display 31, and displays the composite image on the meter display 31.

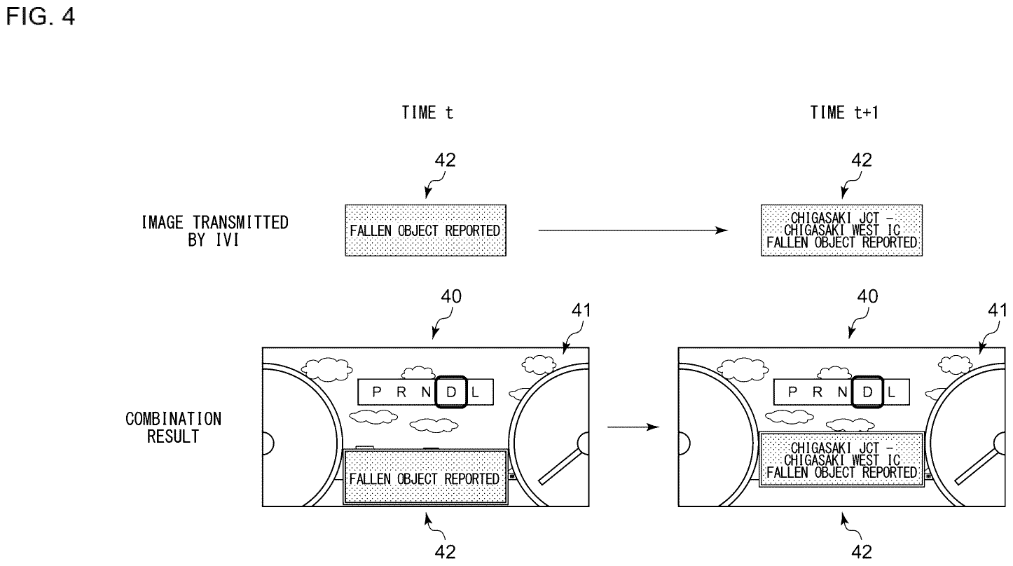

FIG. 4 is a diagram for describing a problem of a related technology. A composite image 40 of FIG. 4 is obtained by combining the IVI image 42 with a meter image 41 indicating states of various meters and gears. In FIG. 4, as a time-based effect, the IVI image 42 is slid upward, and characters in the IVI image 42 are also changed accordingly. In order to implement such an effect, it is necessary to (1) move a display position of the IVI image 42 in the meter image 41 (in other words, a position where the IVI image 42 is combined with the meter image 41) upward, and (2) change the IVI image 42 so as to move the characters in the IVI image 42 downward.

In a case where the above (1) and (2) are not synchronized, the characters in the IVI image 42 may move unnaturally while the position of the IVI image 42 moves upward. However, the GUIApp 22 of the IVI processor 20 determines a content of the IVI image, while the video compositor 35 of the meter processor 30 combines the IVI image at the position designated by the layout information. In addition, a path for transmitting the IVI image from the IVI processor 20 to the meter processor 30 is different from a path for transmitting the layout information from the IVI processor 20 to the meter processor 30. Therefore, there is a possibility that desynchronization between the IVI image and the layout information, which cannot be calculated by the GUIApp 22 of the IVI processor 20, occurs.

Therefore, in the embodiment, a technology for improving expressiveness of the composite image and supporting accurate synchronization between the IVI image and the layout information is proposed. Specifically, the GUIApp 22 of the IVI processor 20 encodes and sets, as pixel data (in other words, color information), information indicating a desirable display mode (a composition position or the like) of the IVI image to be rendered, in a pixel at a upper position on the IVI image. The GUI framework 24 and the window system 25 of the IVI processor 20 output an image added with the color information indicating the display mode similarly to a normal image. The video compositor 35 of the meter processor 30 decodes the received data embedded in the pixel at an upper portion of the image, and combines the IVI image and the meter image according to the display mode indicated by the decoded data.

Hereinafter, referring back to FIG. 1, features of each functional block in the display control system 10 according to the embodiment will be described.

The GUIApp 22 of the IVI processor 20 generates data of a third GUI object including the first GUI object related to IVI to be displayed while being superimposed on the meter image and a second GUI object in which a numerical value related to a display mode of the first GUI object is set as the color information. Data of the first GUI object corresponds to the IVI display data described above. Data of the second GUI object is hereinafter referred to as “additional layout data”, and the data of the third GUI object is hereinafter referred to as “layout-added IVI display data”.

The GUI framework 24 of the IVI processor 20 generates an image of the third GUI object including an image of the first GUI object and an image of the second GUI object based on the layout-added IVI display data. The image of the first GUI object corresponds to the IVI image described above. Hereinafter, the image of the second GUI object is referred to as “layout image”, and the image of the third GUI object is referred to as “layout-added IVI image”.

The display controller 33 of the meter processor 30 displays the IVI image on the meter display 31 in a mode based on the color information of the layout image included in the layout-added IVI image.

The IVI image (in other words, the GUI object indicated by the IVI image) according to the embodiment is displayed by being combined with the predetermined image. In the layout image according to the embodiment, a numerical value related to a mode of combining the IVI image with the predetermined image is set as the color information. The predetermined image is the meter image generated by the GUI software 32 of the meter processor 30. The display controller 33 (video compositor 35) generates the composite image in which the IVI image is superimposed on the meter image in the mode indicated by the color information of the layout image.

The GUIApp 22 of the IVI processor 20 further generates layout information including a position of the layout image in the layout-added IVI image. The display controller 33 (video compositor 35) of the meter processor 30 extracts the IVI image and the layout image from the layout-added IVI image based on the layout information provided from the IVI processor 20.

An operation of the display control system 10 having the above configuration will be described.

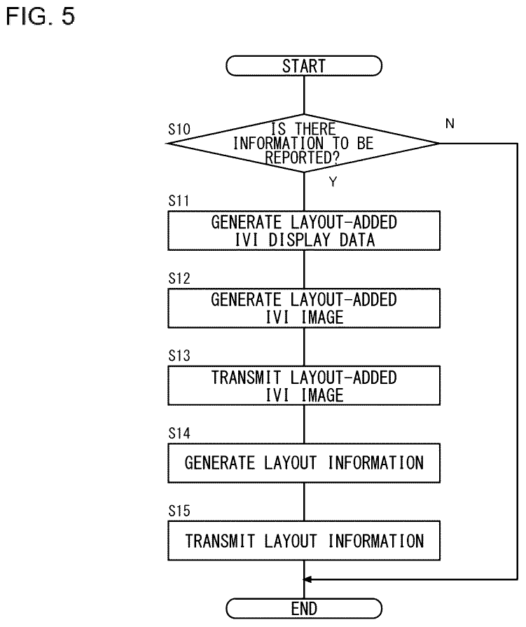

FIG. 5 is a flowchart illustrating an operation of the IVI device 12. In a case where information (for example, navigation information) to reported to an occupant of the vehicle by being displayed on the meter display 31 is generated (Y in S10), the GUIApp 22 of the IVI processor 20 generates the layout-added IVI display data (S11). The GUI framework 24 of the IVI processor 20 analyzes the HTML document as the layout-added IVI display data, and generates the layout-added IVI image which is an image based on the layout-added IVI display data (S12). The window system 25 of the IVI processor 20 transmits the layout-added IVI image to the meter device 14 via the video transmission interface (S13).

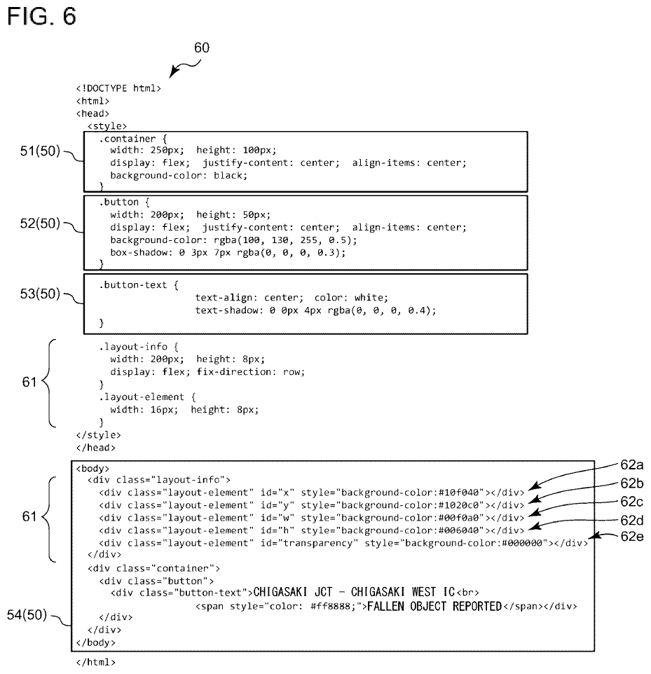

FIG. 6 illustrates an example of the layout-added IVI display data. FIG. 6 illustrates the HTML document as the layout-added IVI display data. Layout-added IVI display data 60 in FIG. 6 includes the IVI display data 50 (the container style data 51, the button style data 52, the text style data 53, and the content data 54) described above with reference to FIG. 2. The information to be reported to the occupant of the vehicle is set in the content data 54.

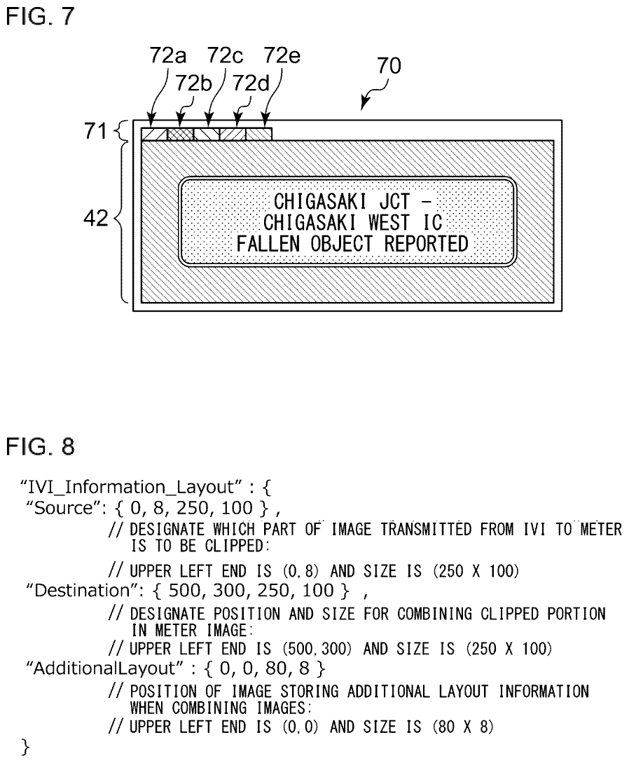

FIG. 7 illustrates an example of the layout-added IVI image. The layout-added IVI image 70 includes the IVI image 42 based on the IVI display data 50.

The layout-added IVI display data 60 in FIG. 6 further includes additional layout data 61. The GUI framework 24 of the IVI processor 20 generates a layout image 71 based on the layout-added IVI display data 60 of FIG. 6. In the embodiment, the GUI framework 24 generates the layout-added IVI image 70 in which the layout image 71 is disposed at a upper position on the IVI image 42 as illustrated in FIG. 7 according to the content data 54 of the layout-added IVI display data 60.

As illustrated in FIG. 6, the additional layout data 61 includes information that designates a region (hereinafter, also referred to as “composite region”) in the meter image to be combined with the IVI image 42. In the embodiment, the additional layout data 61 includes a composite region X coordinate 62a, a composite region Y coordinate 62b, a composite region width 62c (a horizontal width of the composite region), a composite region height 62d (a vertical width of the composite region), and composite region transparency 62e. The composite region X coordinate 62a, the composite region Y coordinate 62b, the composite region width 62c, and the composite region height 62d correspond to the destination attribute of the layout information of FIG. 3.

A value of each of the composite region X coordinate 62a, the composite region transparency 62e, and the like is designated as a value of “background-color” of “layout-element” (a GUI object with 16 pixels in horizontal width and eight pixels in vertical width). Originally, in a case where a hexadecimal color code is designated for “background-color”, a luminance of a red component is designated by the first and second digits from the head, a luminance of a green component is designated by the third and fourth digits from the head, and a luminance of a blue component is designated by the fifth and sixth digits from the head. In the embodiment, the GUIApp 22 of the IVI processor 20 sets a value of the additional layout data 61 at the first digit, the third digit, and the fifth digit from the head as the value of “background-color” of “layout-element”.

Specifically, a value of an X coordinate of the composite region is set as the value of “background-color” of the composite region X coordinate 62a. In FIG. 6, 0x1F4 (500 in 10 decimal, which is the same as in FIG. 3) is set as the value of the X coordinate. Furthermore, a value of a Y coordinate of the composite region is set as the value of “background-color” of the composite region Y coordinate 62b. In FIG. 6, 0x12C (300 in 10 decimal, which is the same as in FIG. 3) is set as the value of the Y coordinate. Furthermore, a value of the horizontal width of the composite region is set as the value of “background-color” of the composite region width 62c. In FIG. 6, 0x0fa (250 in 10 decimal, which is the same as in FIG. 3) is set as the value of the horizontal width.

Furthermore, a value of the height of the composite region is set as the value of “background-color” of the composite region height 62d. In FIG. 6, 0x064 (100 in 10 decimal, which is the same as in FIG. 3) is set as the value of the height. Furthermore, a value of transparency of the composite region is set as the value of “background-color” of the composite region transparency 62e. In FIG. 6, 0x000 (0 in 10 decimal, that is, transparency of 0) is set as the value of the transparency. The composite region transparency 62e may be transparency set for the IVI image 42 at the time of combining. As described above, in the embodiment, 16 levels of colors are used for each of RGB as a value of each item of the additional layout data 61, and a numerical value of 0 to 4095 (16\hat{ }3=4096) can be expressed.

The layout image 71 of FIG. 7 includes a GUI object 72a, a GUI object 72b, a GUI object 72c, a GUI object 72d, and a GUI object 72e. Color information of the GUI object 72a corresponds to the value of the composite region X coordinate 62a of FIG. 6 (the value of “background-color”, and the same applies hereinafter). Color information of the GUI object 72b corresponds to the value of the composite region Y coordinate 62b of FIG. 6. Color information of the GUI object 72c corresponds to the value of the composite region width 62c of FIG. 6. Color information of the GUI object 72d corresponds to the value of the composite region height 62d of FIG. 6. Color information of the GUI object 72e corresponds to the value of the composite region transparency 62e of FIG. 6.

Returning to FIG. 5, the GUIApp 22 of the IVI processor 20 generates the layout information related to the layout-added IVI display data (layout-added IVI image) (S14). The GUIApp 22 transmits the layout information generated in S14 to the meter device 14 via the data transmission interface different from the video transmission interface (S15). In a case where the information to be reported to the occupant of the vehicle by being displayed on the meter display 31 is not generated (N in S10), the processing after S11 is skipped. The IVI device 12 repeatedly executes the processing illustrated in FIG. 5. The processing of S11 to S13 and the processing of S14 to S15 may be executed in parallel.

FIG. 8 illustrates an example of the layout information. The layout information related to the layout-added IVI display data (layout-added IVI image) includes an additional layout attribute (AdditionalLayout) in addition to the source attribute and the destination attribute illustrated in the layout information of FIG. 3. The additional layout attribute includes a horizontal coordinate and a vertical coordinate of an upper left end of the layout image disposed in the layout-added IVI image, and a size (a width and a height) of the layout image. The additional layout attribute of FIG. 8 corresponds to the layout image 71 of FIG. 7 and indicates a position where five “layout-element” objects are disposed. The layout information added with the additional layout attribute can also be said to be information indicating that the IVI image added with the color information (that is, the layout image) indicating the layout information is transmitted.

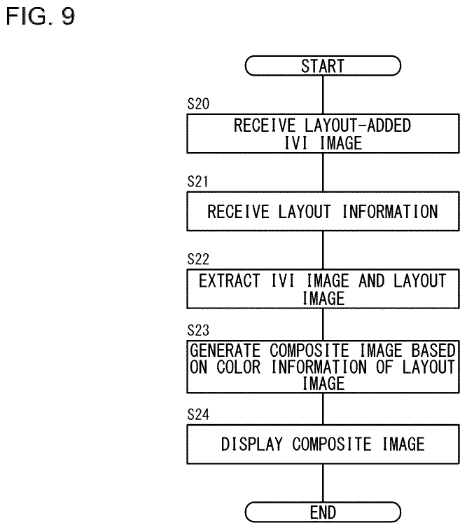

FIG. 9 is a flowchart illustrating an operation of the meter device 14. The video compositor 35 of the meter processor 30 acquires the meter image generated by the GUI software 32 of the meter processor 30. Further, the video compositor 35 receives the layout-added IVI image transmitted from the IVI device 12 via the video transmission interface (S20).

The composite layout manager 34 of the meter processor 30 acquires the layout information generated by the GUI software 32 of the meter processor 30. In addition, the composite layout manager 34 receives the layout information transmitted from the IVI device 12 via the data transmission interface (S21). The composite layout manager 34 passes the acquired or received layout information to the video compositor 35.

In a case where the additional layout attribute is designated in the layout information transmitted from the IVI device 12, the video compositor 35 detects the designation. In a case where the additional layout attribute is not designated in the layout information transmitted from the IVI device 12, the image transmitted from the IVI device 12 is a normal IVI image to which the layout image is not added. In this case, the video compositor 35 generates the composite image by the above-described method according to the related art. Specifically, the video compositor 35 extracts the IVI image from the image data transmitted from the IVI device 12 based on the source attribute of the layout information. The video compositor 35 generates the composite image obtained by combining the IVI image with the region of the meter image indicated by the destination attribute of the layout information.

In FIG. 6 of the present embodiment, the background-color attribute in a DIV element of HTML is used to generate the layout image, but this is an example, and a method using another type of element or a method using another attribute may be used as long as a similar video can be generated.

In a case where the additional layout attribute is designated in the layout information transmitted from the IVI device 12, the video compositor 35 extracts the IVI image from the layout-added IVI image based on the source attribute of the layout information. At the same time, the video compositor 35 extracts the layout image from the layout-added IVI image based on the additional layout attribute of the layout information (S22).

The video compositor 35 specifies the layout information from the extracted layout image. As a premise, in the embodiment, color information of one item of the layout information is set as color information of the GUI object with 16 pixels in horizontal width and eight pixels in vertical width (hereinafter, also referred to as “unit object”). The video compositor 35 acquires the color information (6-digit hexadecimal color code in the embodiment) of each unit object included in the layout image. The video compositor 35 acquires values of the first, third, and fifth digits from the head of the 6-digit hexadecimal color code as values of the layout information.

The video compositor 35 stores in advance a correspondence relationship between each unit object disposed in the layout image and an item of the layout information. In the embodiment, each unit object of the layout image corresponds to each item of the destination attribute of the layout information.

For example, the video compositor 35 derives the value (for example, 0x1f4) of the composite region X coordinate based on the color information of the GUI object 72a of FIG. 7. Furthermore, the video compositor 35 derives the value (for example, 0x12c) of the composite region Y coordinate based on the color information of the GUI object 72b of FIG. 7. Further, the video compositor 35 derives the value (for example, 0x0fa) of the composite region width based on the color information of the GUI object 72c of FIG. 7. In addition, the video compositor 35 derives the value (for example, 0x064) of the composite region height based on the color information of the GUI object 72d of FIG. 7. In addition, the video compositor 35 derives the value (for example, 0x000) of the composite region transparency based on the color information of the GUI object 72e of FIG. 7.

The video compositor 35 extracts the IVI image from the image data transmitted from the IVI device 12 based on the source attribute of the layout information. The video compositor 35 combines the IVI image in which the transparency indicated by the composite region transparency is set for a region in the meter image specified by the value of each of the composite region X coordinate, the composite region Y coordinate, the composite region width, and the composite region height derived from each unit object of the layout image, regardless of the value indicated by the destination attribute of the layout information (S23). The video compositor 35 causes the meter display 31 to display the composite image obtained by combining the IVI image with the meter image (S24).

With the display control system 10 according to the embodiment, the IVI image to be displayed on the meter display 31 and the layout data related to the display mode of the IVI image (for example, the composite mode with the meter image) can be transmitted to the meter processor 30 (for example, the video compositor 35) at the same timing. As a result, a timing of a change in the IVI image and a timing of a change in the display mode of the IVI image (for example, a change in the composition position with the meter image) can be accurately matched, so that the expressiveness of the composite image can be improved.

In addition, with the display control system 10 according to the embodiment, in a case where the processor of the meter device 14 having a relatively high safety requirement combines the image generated by the processor of the IVI device 12 having a relatively low safety requirement with the meter image, the expressiveness of the composite image can be improved. In addition, with the display control system 10, the IVI image and the layout image can be extracted from the layout-added IVI image by using an existing mechanism of generating the composite image based on the layout information.

The present disclosure has been described above based on the embodiment. It is to be understood by those skilled in the art that the embodiment is an example, various modified examples can be made for combinations of the constituent elements or processing processes of the embodiment, and such modified examples are also within the scope of the present disclosure.

A first modified example will be described. In the above embodiment, the color information corresponding to the value of the destination attribute of the layout information related to the layout-added IVI image is set as the layout image in the layout-added IVI image. Therefore, the layout information related to the layout-added IVI image does not have to include designation of the destination attribute. However, it is desirable that the destination attribute is also designated in the layout information related to the layout-added IVI image. This is because even a meter processor according to a related art that does not use the color information of the layout image as the layout information can combine images based on the destination attribute.

A second modified example will be described. In the above embodiment, 16 levels of colors are used for each of RGB as the color information of the layout image, and numerical values of 0 to 4095 can be expressed. As a modified example, the color information of the layout image may be determined based on a more complicated calculation formula. Furthermore, the layout image may include color information corresponding to a checksum or cyclic redundancy check (CRC) data. This makes it possible to detect a data transmission error from the IVI processor 20 to the meter processor 30. Furthermore, the GUIApp 22 of the IVI processor 20 may set colors of at least some GUI objects of the layout image to a predetermined pattern indicating the layout image. Consequently, the video compositor 35 of the meter processor 30 can accurately detect the layout image disposed in the layout-added IVI image.

A third modified example will be described. The GUI framework 24 of the IVI device 12 according to the embodiment includes the HTML rendering engine. As a modified example, the GUI framework 24 may include other types of rendering engines. For example, the GUI framework 24 may include a Flutter (trade mark or registered trademark) rendering engine or may include an Android (trade mark or registered trademark) rendering engine. The GUIApp 22 of the IVI processor 20 may generate the layout-added IVI display data in a format corresponding to a type of rendering engine used by the GUI framework 24.

A fourth modified example will be described. In the embodiment, the layout information is described in a JavaScript Object Notation (JSON) format (“JavaScript” is a trademark or a registered trademark), but the layout information may be described in another format. Furthermore, in the layout image and the layout information according to the embodiment, the position and size of the IVI image are designated in units of pixels in the meter device 14. However, the position and size of the IVI image may be designated with more abstract values. For example, in the layout image and the layout information, designation such as displaying a percentage position at which the IVI image is to be displayed on a screen (or on the meter image) may be made. Further, the composite layout manager 34 of the meter processor 30 may be configured to calculate a specific display position of the IVI image.

A fifth modified example will be described. In the embodiment, the layout image is disposed at a top position on the IVI image, but the layout image may be disposed at another position in the layout-added IVI image. For example, the layout image may be disposed at a position under the IVI image. In a case where the layout image is positioned under the IVI image, a coordinate value of the IVI image does not change between a case where the layout image is added and a case where the layout image is not added. Therefore, even in a case where the same layout-added IVI image is transmitted to both the meter processor corresponding to a function of acquiring the layout information from the IVI image and the meter processor that does not correspond to the above function, there is an advantage that combining processing is executed without any problem in any meter processor.

A sixth modified example will be described. In the embodiment, a first processor (that is, the IVI processor 20) that generates the first image to be combined and a second processor (that is, the meter processor 30) that generates the second image to be combined are stored in separate units. As a modified example, the IVI processor 20 and the meter processor 30 may be stored in a single unit. In this case, the image data and the layout information may be transmitted and received between the IVI processor 20 and the meter processor 30 by sharing a memory space between the IVI processor 20 and the meter processor 30.

In addition, both the IVI processor 20 and the meter processor 30 may be virtual processors. A single physical processor may execute both the processing in the IVI processor 20 and the processing in the meter processor 30. In other words, the functions of the IVI processor 20 (for example, the GUIApp 22, the GUI framework 24, and the window system 25) and the functions of the meter processor 30 (for example, the GUI software 32, the display controller 33, the composite layout manager 34, and the video compositor 35) may be implemented in a single physical processor. The single physical processor may include a first OS (here, referred to as “IVIOS”) on which the functions of the IVI processor 20 operate, and a second OS (here, referred to as “meter OS”) on which the functions of the meter processor 30 operate. The meter OS typically has a different safety requirement than that of the IVIOS, and specifically has a higher safety requirement than that of the IVIOS. In this case, a memory shared by multiple virtual processors may be used to transmit and receive the image data and the layout information between the IVI processor 20 and the meter processor 30.

In the above-described embodiment, a mode in which one numerical value of the layout information is directly converted as color information of one rectangular component has been described. However, as a modified example, one numerical value of the layout information may be expressed by color information of a plurality of GUI components. Furthermore, in the above-described embodiment, the layout information is expressed using all colors of RGB, but as a modified example, the layout information may be expressed by a black-and-white dot pattern or the like. As another modified example, the IVI processor 20 may add the layout information as an image of a two-dimensional barcode, and the meter processor 30 may read the image of the two-dimensional barcode.

Any combination of the plurality of embodiments and the plurality of modified examples described above is also useful as an embodiment of the present disclosure. A new embodiment generated by the combination has the effect of each of the combined embodiments and modified examples. In addition, it will be understood by those skilled in the art that the functions to be performed by the constituent elements described in the claims are implemented by a single constituent element or cooperation of the constituent elements described in the embodiments and the modified examples.

### Supplementary Note

The following technologies are disclosed by the description of the above embodiments and modified examples.

### [Technology 1]

A display control system including:
a generator structured to generate data of a third GUI object including a first GUI object and a second GUI object in which a numerical value related to a display mode of the first GUI object is set as color information;
a renderer structured to generate an image of the third GUI object based on the data of the third GUI object; and a display controller structured to display the first GUI object in a mode based on the color information of the second GUI object included in the image of the third GUI object.

With the display control system, since an image to be displayed (first GUI object) and a numerical value related to a display mode of the image are transmitted to the display controller at the same timing, a timing of a change in the image and a timing of a change in the display mode of the image can be accurately matched.

### [Technology 2]

The display control system according to Technology 1, in which
the first GUI object is displayed by being combined with a predetermined image, and
the second GUI object is obtained by setting, as the color information, a numerical value related to a mode of combining the first GUI object with the predetermined image.

With the display control system, since an image to be displayed (first GUI object) and a numerical value related to a composite mode of the image are transmitted to the display controller at the same timing, a timing of a change in the image and a timing of a change in the composite mode of the image can be accurately matched.

### [Technology 3]

The display control system according to Technology 1 or 2, in which
the generator and the renderer are implemented in a first processor, and
the display controller is implemented in a second processor having a safety requirement different from a safety requirement of the first processor.

With the display control system, in a case where the second processor having the safety requirement different from that of the first processor displays an image generated by the first processor, a timing of a change in the image and a timing of a change in a display mode of the image can be accurately matched.

### [Technology 4]

The display control system according to Technology 1 or 2, in which
the renderer and the display controller are implemented in a single processor,
the single processor includes a first operating system (OS) on which the renderer operates and a second OS on which the display controller operates, and
the second OS has a safety requirement different from a safety requirement of the first OS.

### [Technology 5]

The display control system according to Technology 1 or 2, in which
the generator and the renderer are implemented in a processor of an information device mounted on a vehicle, and
the display controller is implemented in a processor of a meter device mounted on the vehicle.

With the display control system, in a case where the processor of the meter device displays an image generated by the processor of the information device, a timing of a change in the image and a timing of a change in a display mode of the image can be accurately matched.

### [Technology 6]

The display control system according to any one of Technologies 1 to 5, in which
the generator further generates layout information including a position of the second GUI object in the third GUI object, and
the display controller extracts an image of the first GUI object and an image of the second GUI object from the image of the third GUI object based on the layout information.

With the display control system, it is possible to extract the image of the first GUI object and the image of the second GUI object from the image of the third GUI object by using an existing mechanism of designating a screen layout using the layout information.

### [Technology 7]

A display control method executed by a computer, the display control method including:
generating data of a third GUI object including a first GUI object and a second GUI object in which a numerical value related to a display mode of the first GUI object is set as color information;
generating an image of the third GUI object based on the data of the third GUI object; and
displaying the first GUI object in a mode based on the color information of the second GUI object included in the image of the third GUI object.

With the display control method, since an image to be displayed (first GUI object) and a numerical value related to a display mode of the image are transmitted to the display controller at the same timing, a timing of a change in the image and a timing of a change in the display mode of the image can be accurately matched.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the benefit of priority from the prior Japanese Patent Application No. 2024-023772, filed on Feb. 20, 2024, the entire contents of which are incorporated herein by reference.

What is claimed is:

1. A display control system comprising:
a generator structured to generate data of a third GUI object including a first GUI object and a second GUI object in which a numerical value related to a display mode of the first GUI object is set as color information;
a renderer structured to generate an image of the third GUI object based on the data of the third GUI object; and
a display controller structured to display the first GUI object in a mode based on the color information of the second GUI object included in the image of the third GUI object.

2. The display control system according to claim 1, wherein
the first GUI object is displayed by being combined with a predetermined image, and
the second GUI object is obtained by setting, as the color information, a numerical value related to a mode of combining the first GUI object with the predetermined image.

3. The display control system according to claim 1, wherein
the generator and the renderer are implemented in a first processor, and
the display controller is implemented in a second processor having a safety requirement different from a safety requirement of the first processor.

4. The display control system according to claim 1, wherein
the renderer and the display controller are implemented in a single processor,
the single processor includes a first operating system (OS) on which the renderer operates and a second OS on which the display controller operates, and
the second OS has a safety requirement different from a safety requirement of the first OS.

5. The display control system according to claim 1, wherein
the generator and the renderer are implemented in a processor of an information device mounted on a vehicle, and
the display controller is implemented in a processor of a meter device mounted on the vehicle.

6. The display control system according to claim 1, wherein
the generator further generates layout information including a position of the second GUI object in the third GUI object, and
the display controller extracts an image of the first GUI object and an image of the second GUI object from the image of the third GUI object based on the layout information.

7. A display control method executed by a computer, the display control method comprising:
generating data of a third GUI object including a first GUI object and a second GUI object in which a numerical value related to a display mode of the first GUI object is set as color information;
generating an image of the third GUI object based on the data of the third GUI object; and
displaying the first GUI object in a mode based on the color information of the second GUI object included in the image of the third GUI object.
